(19) United States
(12) Patent Application Publication
(10) Pub. No.: US 2003/0224934 A1
(43) Pub. Date: Dec. 4, 2003

(54) Structured packing for a column

(76) Inventors: Mathias Haake, Mannheim (DE); Gerd Kaibel, Lampertheim (DE)

Correspondence Address: Herbert B. Keil, KEIL & WEINKAUF, 1350 Connecticut Ave., N.W., Washington, DC, 20036, US

(21) Appl. No.: 10/446,652

(22) Filed: May 29, 2003

(30) Foreign Application Priority Data
Jun. 4, 2002 (DE) 10224759.5

(51) Int. Cl. B01J 20/00

(52) U.S. Cl. 502/439

(57) ABSTRACT

A description is given of a structured packing for a column for carrying out a distillation or reactive distillation which is formed from a three-dimensional body which substantially completely fills the column cross section and which was obtained from two or more differently structured webs of a nonwoven material by winding up or laying one on top of the other and is chemically and mechanically stable under the processing conditions of distillation or reactive distillation.

The invention relates to a structured packing for a column for carrying out a distillation or reactive distillation, and a use.

In distillations or reactive distillations which are generally carried out in heterogeneous catalysis, to improve their transport and heat exchange, an interfacial area as large as possible or, in the case of reactive distillations, alternatively a catalyst surface area as large as possible, is sought. Differing internals are used for this, in particular plates, random packings or structured packings, structured packings in cross-channel structure being particularly widely spread.

To improve the mass transport area and catalyst surface area in heterogeneously catalyzed reactive distillations, it has been proposed, for example, to apply the active catalyst composition directly to structured packings which correspond, with respect to their geometry, to the types known from distillation technology.

The type Katapak-M from Sulzer AG, CH-8404 Winterthur is an example of this. A disadvantage for its wide industrial use is that catalytically active compositions frequently cannot be applied to such structured packings with the required abrasion resistance.

More widespread are therefore structured packings which use conventional particulate catalysts. The catalyst particles are introduced, for example, in pockets made of wire mesh which either serve directly as distillation internals, such as the type Katapak-S from Sulzer AG, CH-8404 Winterthur. Flat pockets are also known, which are placed between the individual layers of the structured distillation packings, such as the type Multipack from Montz GmbH, D-40723 Hilden. Structured packings of this type, however, are subject to faults, since uniform flow through the catalyst requires that the respective liquid trickle-flow rates be maintained exactly, which proves difficult in practice.

The “Bales” from CDTech, Houston, USA, are made up in a similar manner, but the pocket structures are significantly coarser and the number of separation plates which can be achieved per meter of column height are lower.

In addition, internals for reactive distillations are known in the form of stable three-dimensional bodies, for example the extruded cordierite monoliths described in U.S. Pat. No. 5,235,102. These monoliths, that is to say one-piece shaped bodies, are fabricated in the prior art as extrudates. Production is comparatively complex and requires expensive machinery which is subject to wear. It is also disadvantageous that the monoliths can only be produced having comparatively small dimensions up to about 0.2 m. This necessitates extensive further processing in order to fabricate the individual monoliths having the required dimensional stability, in order that during operation no unwanted maldistributions of the liquid and gaseous phases occur.

It is an object of the present invention to provide a structured packing for a column for carrying out a distillation or reactive distillation, which can be fabricated simply and inexpensively for the preferably cylindrically constructed distillation columns or reactive distillation columns of virtually any diameter in the range from about 0.05 to 5 m.

We have found that this object is achieved by a structured packing for a column for carrying out a distillation or reactive distillation, which structured packing is formed by a three-dimensional body which substantially completely fills the column cross section and which was obtained from two or more differently structured webs of a nonwoven material by winding them up or laying them one on top of the other, and which is chemically and mechanically stable under the processing conditions of distillation or reactive distillation.

We have surprisingly found that, in contrast to the conviction prevailing in specialist circles that, in distillation columns or reactive distillation columns, a substantially or virtually complete uniform distribution of the mixture to be separated is required over the entire cross section of the apparatus, need not necessarily be complied with. In contrast, it is possible, for less demanding separation tasks, to use the inventive structured packings which can be fabricated economically advantageously and are based on a nonwoven material structure.

The inventive structured packings are technically very much simpler and thus can be fabricated significantly less expensively than known extruded monoliths, without exhibiting disadvantageous characteristics with respect to hydraulic resistance, liquid holdup and the residence time distribution of the gas and the liquid.

The inventive structured packings can be fabricated as three-dimensional bodies in a simple manner by winding up or laying one on top of the other two or more differently structured webs of a nonwoven material, which can be substantially fitted to the column cross section. Substantially in the present case is taken to mean that an exact fit to the column cross section is not necessary, but manufacturing tolerances are allowed. Fitting the geometry of the three-dimensional body to the column cross section is intended to prevent bypass streams of the mixture subjected to the distillation or reactive distillation. Small edge gaps, which generally do not exceed 1 or 2 mm, are usually not damaging to this.

The three-dimensional body is preferably constructed as a roll which was obtained by winding up two or more differently structured webs of a nonwoven material. However, other geometric shapes are also possible, in particular a parallelepipedal form obtained by laying webs one on top of the other.

The term nonwoven material designates in a known manner flexible porous flat materials belonging to the bonded (textile) materials which are not fabricated by the classical method of weaving warp and weft, or by knitting, but by entangling and/or cohesive and/or adhesive bonding of (textile) fibers. Cohesion generally results from the fibers' own adhesion, mechanical consolidation by needling, meshing or by intermingling using strong water jets being possible. Adhesively consolidated nonwovens are produced by sticking together the fibers using liquid binders or by melting or dissolving what are termed binding fibers which are added to the nonwoven during fabrication (from Römpp Chemie Lexikon [Römpp's Chemistry Lexicon], 9th edition, page 4955).

To produce an inventive structured packing, a nonwoven material is used as starting material which is present in the form of webs in a handleable width, generally from 0.05 m to 5 m, in theoretically endless lengths.

The starting material is two or more webs which must be differently structured, that is to say have differing degrees of waviness. It is possible in this case to keep a first nonwoven material web with flat structure. A second web is fabricated in rippled or corrugated shape, that is to say structured with regular ripples or corrugations, corresponding to the structured packings made from metal sheets known from distillation technology.

By winding up two or more differently structured webs of a nonwoven material, a roll is obtained whose circumference can be controlled without problem in such a manner that it corresponds to the inner diameter of the column for use with which the structured packing is intended.

It is also without problem to control the desired height of the structured packing in such a manner that webs of appropriate width are used as starting material for forming the roll.

A process engineer will select the three-dimensional body, in particular the roll or the nonwoven material forming it, in such a manner as to give chemical and mechanical stability under the processing conditions of distillation or reactive distillation. It is known that nonwoven materials, owing to the multitude of available raw materials, the possible combinations and consolidation methods, can be made having any purpose-specific properties (see Römpp Chemie Lexikon [Römpp's Chemistry Lexicon], as cited above).

It is also possible to form the structured packing from a three-dimensional body, in particular from a roll, which consists of two rippled or corrugated webs having a different angle of inclination of the ripple or corrugation to the longitudinal axis of the web or having the same angle of inclination of the ripple or corrugation, but with reversed sign, and/or having differing depth of the ripples or corrugations.

The particularly preferred structure of the webs having the same angle of inclination of the ripples or corrugations, but with reversed sign, achieves a structure similar to the cross-channel structure of known structured distillation packings. The angle of inclination of the corrugations or ripples to the longitudinal axis of the web(s) can be in the range from 10 to 90°, preferably in the range from 10 to 80°, particularly preferably in the range from 30 to 60°. It is thus possible, by simple structuring of the nonwoven material web(s) to impose substantially any angle of inclination of the corrugations or ripples, so that in the finished structured packing corresponding flow channels are formed which are inclined toward the longitudinal direction of the structured packing. This achieves an improved transverse exchange of the liquid phase, and in particular also the gaseous phase, causing an evening out of the flows and of the resultant concentration profiles.

In a special embodiment it is possible to form the angle of inclination of the ripples or corrugations to the longitudinal direction of the web at 90°.

Preferably, one or more webs can have perforations. As a result of this measure, adjacent flow channels are partially flow-connected, causing an additional improvement in the transverse exchange of gas and liquid. This achieves a geometry of the flow channels which corresponds, in the fundamentals, to the cross-channel structured packings preferably used in distillation technology.

It is preferably possible to construct a structured packing in such a manner that one or more discs are separated off from the three-dimensional body, in particular from the roll, by mechanical separation perpendicular to the direction of winding. By this means, in a simple manner, a structured packing can be obtained in a height optimum for the respective application.

To further improve the transverse exchange over the structured packing cross section, it is possible to construct the structured packing from a plurality of elements which are obtained by mechanical division from the roll or from the disc or discs and which are assembled in such a manner that they completely fill the column cross section, adjacent elements preferably being offset to one another, in particular each offset by 90°.

The nonwoven material which is the basis for the three-dimensional body forming the structured packing, can in principle consist of any material which is chemically and mechanically stable under the processing conditions of the actual distillation or reactive distillation. It can preferably be formed from a ceramic material, from one or more plastics, or from carbon. Suitable ceramic materials are, for example, aluminum oxide and/or silicon dioxide, in particular fabrics made from asbestos substitutes. Plastics which can be used are, for example, polyamides, polyesters, polyvinyls, polyethylene, polypropylene, polytetrahydrofluoroethylene, etc.

It is possible to consolidate the nonwoven material by means of a catalytically active or inactive binder, in particular using a proton acceptor or a proton donor. It is thus possible to incorporate into the nonwoven material, in a simple manner and with excellent adhesion, the most varied catalytically active materials. The binder can be formed, for example, from one or more of the substances listed hereinafter: silicates, aluminates, zinc oxide, magnesium oxide, titanium dioxide, zirconium dioxide, aluminum oxide, lanthanum series oxides, silicon oxynitrides or spinels.

It is also possible to treat the nonwoven material webs and/or the resultant three-dimensional bodies with catalytically active material, in particular to impregnate, immerse or spray them.

The invention also relates to the use of a three-dimensional body, in particular a roll, which is formed from two or more differently structured webs of a nonwoven material as structured packing for a column for carrying out a distillation or reactive distillation.

We claim:

1. A structured packing for a column for carrying out a distillation or reactive distillation, which structured packing is formed by a three-dimensional body which substantially completely fills the column cross section and which was obtained from two or more differently structured webs of a nonwoven material by winding them up or laying them one on top of the other, and which is chemically and mechanically stable under the processing conditions of distillation or reactive distillation.

2. A structured packing as claimed in claim 1, wherein the three-dimensional body is a roll which was obtained by winding up two or more differently structured webs of a nonwoven material.

3. A structured packing as claimed in claim 1, wherein the three-dimensional body is formed from two webs, one web being flat and the other web being rippled or corrugated.

4. A structured packing as claimed in claim 1, wherein the three-dimensional body is formed from two rippled or corrugated webs having different angles of inclination of the ripples or corrugations to the longitudinal axis of the web or having the same angle of inclination of the ripples or corrugations, but with reversed sign, and/or having different depths of the ripples or corrugations.

5. A structured packing as claimed in claim 3, wherein the angle of inclination of the corrugations or ripples to the longitudinal axis of the web(s) is in the range from 10 to 90°, preferably in the range from 10 to 80°, particularly preferably in the range from 30 to 60°.

6. A structured packing as claimed in claim 3, wherein the angle of inclination of the ripples or corrugations to the longitudinal direction of the web is 90°.

7. A structured packing as claimed in claim 1, wherein one or more webs have (has) perforations.

8. A structured packing as claimed in claim 2, wherein it consists of one or more discs which were obtained from the roll by mechanical separation perpendicular to the direction of winding.

9. A structured packing as claimed in claim 1, wherein it consists of a plurality of elements which are obtained by mechanical division from the three-dimensional body, in particular from the roll or from the disc(s) and are then assembled in such a manner that they substantially completely fill the column cross section, adjacent elements preferably being offset to one another, in particular each offset by 90°.

10. A structured packing as claimed in claim 1, wherein the nonwoven material is formed from ceramic material, one or more plastics, or carbon.

11. A structured packing as claimed in claim 1, wherein the nonwoven material is consolidated using a catalytically active or inactive binder, in particular using a proton acceptor or proton donor.

12. A structured packing as claimed in claim 1, wherein the binder is formed from one or more of the substances listed hereinafter: silicates, aluminates, zinc oxide, magnesium oxide, titanium dioxide, zirconium dioxide, aluminum oxide, lanthanum series oxides, silicon oxynitrides or spinels.

13. A structured packing as claimed in claim 1, wherein the webs and/or the three-dimensional body is (are) treated with catalytically active material, in particular is (are) impregnated, immersed or sprayed.

14. The method of use of a three-dimensional body, in particular a roll, which is formed from two or more differently structured webs of a nonwoven material, as structured packing for a column for carrying out a distillation or reactive distillation.
